(19) United States
(12) Patent Application Publication
(10) Pub. No.: US 2023/0275303 A1
(43) Pub. Date: Aug. 31, 2023

(54) RECHARGEABLE BATTERY PACK HAVING A POUCH CELL, AND METHOD

(71) Applicant: Hilti Aktiengesellschaft, Schaan (LI)

(72) Inventors: Moses ENDER, Buchs (CH); Nora MARTINY, Herrsching-Breitbrunn (DE); Robert STANGER, Kaufbeuren (DE); Klaus HAUSER, Schwabmunchen (DE); Matthias LEPIORZ, Chemnitz (DE); Bernd ZIEGLER, Schabmunchen (DE); Kathrin SAX, Scheuring (DE)

(21) Appl. No.: 18/015,842

(22) PCT Filed: Jul. 12, 2021
(86) PCT No.: PCT/EP2021/069337

§ 371 Date: Jan. 12, 2023

(30) Foreign Application Priority Data
Jul. 22, 2020 (EP) 20187152.2

(51) Int. Cl. H01M 50/242; H01M 50/211; H01M 10/052

(52) U.S. Cl. CPC H01M 50/242; H01M 10/052; H01M 50/211; H01M 2220/30

(57) ABSTRACT

A rechargeable battery pack for an electric hand-held power tool, wherein the rechargeable battery pack has a housing with at least one pouch cell arranged therein, wherein a deformable pressure equalizing element is arranged parallel to the pouch cell in such a way that the pressure equalizing element can yield to an increase in volume of the pouch cell, wherein the pressure equalizing element is profiled, so that a convection current can pass along the pouch cell in spite of the increase in volume of the pouch cell.

The present invention relates to a rechargeable battery pack for an electric hand-held power tool, wherein the rechargeable battery pack has a housing with at least one pouch cell arranged therein, wherein a deformable pressure equalizing element is arranged parallel to the pouch cell in such a way that the pressure equalizing element can yield to an increase in volume of the pouch cell.

### BACKGROUND

A rechargeable battery pack of the type mentioned at the outset is known from EP 3 499 600 A1.

WO 2014/206323 A1 discloses a rechargeable battery pack for a portable power tool, wherein the rechargeable battery pack has a multiplicity of rechargeable battery cells which are supported within a housing in an elastically deformable frame which surrounds at least a portion of each rechargeable battery cell, wherein each elastically deformable frame side edge in one way involves providing mechanical protection for the sides of each of the multiplicity of rechargeable battery cells.

DE 10 2014 226 260 A1 describes a battery cell housing for accommodating an electrode ensemble of a battery cell having an anode, a cathode and an electrolyte positioned between the anode and the cathode, comprising a bottom region, side walls connected to it and a cover that closes the battery cell housing at its surface, wherein the bottom face, at least one side wall or the cover of the battery cell housing has, at least in regions, a waved or folded structure in such a way that the battery cell housing elastically changes volume owing to the waved or folded structure.

### SUMMARY OF THE INVENTION

It is an object of the present invention to provide a rechargeable battery pack that provides the basis for comparatively high operational safety.

The present invention provides that the pressure equalizing element is profiled so that a convection current can pass along the pouch cell in spite of the increase in volume of the pouch cell.

The invention includes the finding that, in the case of rechargeable battery packs of the prior art, the rechargeable battery cells are cast under prestress in a resin-hardener mixture or delimited by continuously solid pressure equalizing elements. It has been observed that an increase in volume of the pouch cells — known as swelling — can lead to mechanical stresses and forces, in particular on the housing. Convection along the pouch cells, which is advantageous for the pouch cells, typically comes to a stop during the course of swelling. In particularly extreme cases, the rechargeable battery cells themselves, but also the housing of the rechargeable battery pack, can be damaged. The so-called swelling has hitherto been unavoidable and, in particular in the case of pouch cells, occurs due to the pouch-cell-specific aging of the cells.

On account of the pressure equalizing element being profiled according to the invention, a convection current can pass along the pouch cell in spite of the increase in volume of the pouch cell. Cooling of the pouch cell — be it by free and/or by forced convection — is therefore basically still possible. In other words, a suitable profiling of the pressure equalizing elements can have the effect that open volumes (cavities), through which said convection current can pass, remain even when the pouch cell swells up. The cavities accordingly preferably serve not only to ensure the elastic structure (and therefore to accommodate the increase in volume) but also to cool the pouch cell. The rechargeable battery pack can have an electric fan that forces a convection current along the pouch cell.

In a particularly preferred refinement, the pressure equalizing element is profiled exclusively within a projection surface of the pouch cell, the projection surface being oriented perpendicular to a stacking direction of the pouch cell. This allows a particularly compact layer structure. In a particularly preferred refinement, the pressure equalizing element has a waved, trapezoidal or honeycomb-like profile. The pressure equalizing element can have a surface profile gridded with flat-topped mountain shapes. It has been found to be advantageous if the pressure equalizing element is free of a continuously straight air duct, in particular free of an air duct that is continuously straight perpendicular to the stacking direction. The pressure equalizing element can have one or more apertures in order to promote a convection current.

It has proven to be advantageous if the pressure equalizing element has a material elasticity that is greater than a cell elasticity of the pouch cells. In a further preferred refinement, the pressure equalizing element is reversibly-elastically deformable. The pressure equalizing element is preferably reversibly-elastically deformable at least in the stacking direction. In a particularly preferred refinement, the pressure equalizing element is or comprises an elastomer. The pressure equalizing element is preferably selected from the group: polyurethane, butadiene rubber, butyl rubber, ethylene-propylene-diene rubber and silicone rubber. In a further preferred refinement, the pressure equalizing element comprises a phase-change material. For example, the pressure equalizing element can have paraffin-filled chambers which can buffer temporary temperature peaks within the rechargeable battery pack - which typically occur in the case of a high current consumption.

In a particularly preferred refinement, the pressure equalizing element is provided in the form of at least one insert element which is inserted or is to be inserted between the pouch cells. If a plurality or a large number of pouch cells are provided, there is preferably one insert element each between adjacent pouch cells. The insert elements are preferably of a flat form, wherein a surface can be essentially the same size as a surface of a respective pouch cell. It has been found to be advantageous if the pressure equalizing element does not overlap the pouch cell.

In a further preferred refinement, the pressure equalizing element is located between at least one of the pouch cells and a wall of the housing. If the pressure equalizing element is provided in the form of at least one insert element, this can be arranged between an outer pouch cell and the wall of the housing.

It has been found to be particularly advantageous that each of the pouch cells adjoins the pressure equalizing element on both sides. The pouch cells are particularly preferably designed as lithium-polymer cells. It has been found to be advantageous if the pressure equalizing element is an electrical insulator. In a particularly preferred embodiment, the no-load voltage of the rechargeable battery pack is limited to 60 V DC voltage.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

In the figures, identical and similar components are denoted by the same reference signs. In the figures:

FIG. 1A shows a first preferred exemplary embodiment of a rechargeable battery pack according to the invention in an intact state, with the pressure equalizing element being provided in the form of an insert element; and

FIG. 1B shows the rechargeable battery pack in an expanded state.

### DETAILED DESCRIPTION

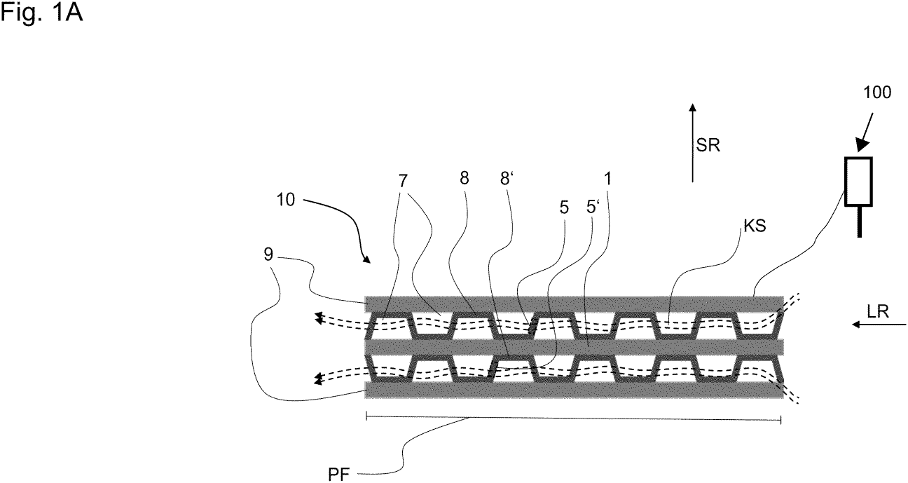

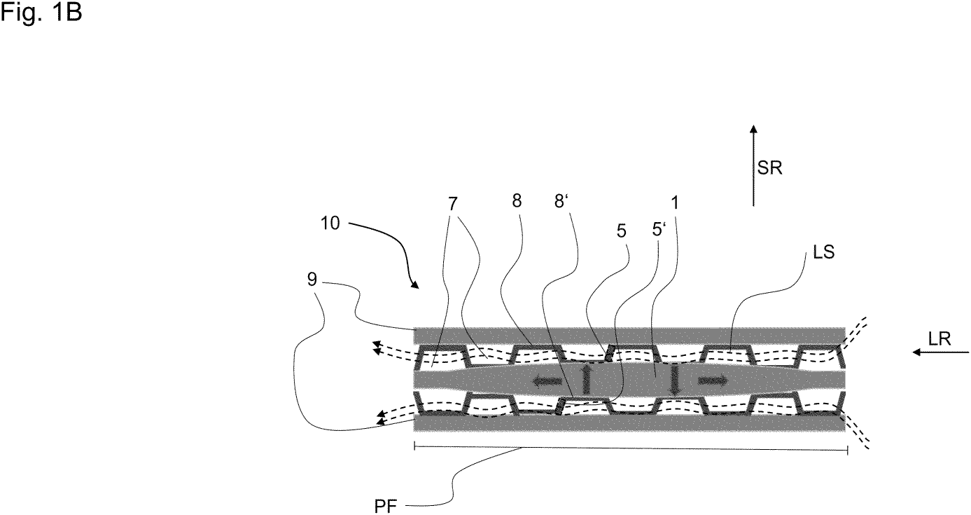

A schematic representation of a particularly preferred exemplary embodiment of a rechargeable battery pack 10 according to the invention is shown in FIGS. 1A and 1B.

The rechargeable battery pack 10 serves for supplying electrical power to an electric hand-held power tool, shown solely schematically as 100 here. The rechargeable battery pack 10 has a housing — symbolized here by two housing walls 9 by way of example — with a pouch cell 1 arranged therein. In other exemplary embodiments, a plurality of pouch cells can be provided. FIG. 1A shows the rechargeable battery pack 10 with an intact pouch cell 1. In FIG. 1B, the rechargeable battery pack 10 is shown with an inflated pouch cell 1.

A respective pressure equalizing element 8, 8′ is located between the pouch cell 1 and a respective housing wall 9. In the exemplary embodiment shown in FIGS. 1A and 1B, the pressure equalizing elements 8, 8′ are designed as insert elements which can be reversibly-elastically deformed at least in the stacking direction SR, so that the pressure equalizing elements 8, 8′ yield to an increase in volume of the pouch cell 1 (cf. FIG. 1B). As can be seen in FIG. 1, the pressure equalizing elements 8, 8′, in their longitudinal direction LR, extend parallel to a stacking direction SR of the pouch cell 1. It is clear from viewing FIGS. 1A and B in combination that both pressure equalizing elements 8, 8′ — irrespective of the state of the pouch cell 1 — are always in contact with the pouch cell 1 at least in sections.

According to the invention, the pressure equalizing elements 8, 8′ are profiled, so that a convection current KS can pass along both sides of the pouch cell 1 in spite of the increase in volume of the pouch cell 1 (cf. FIG. 1B). By way of example, the pressure equalizing elements 8, 8′ have a trapezoidal profile. Due to the trapezoidal profiling of the pressure equalizing elements 8, 8′, open volumes 7, through which said convection current KS can pass, remain even when the pouch cell swells up (cf. FIG. 1B). It should be pointed out that, due to the two-dimensional representation of FIGS. 1A and 1B, apertures 5, 5′ advantageously formed in the pressure equalizing elements 8, 8′ are only shown in dashed lines. The apertures 5, 5′ enable or promote the convection current KS.

It can be clearly seen in FIGS. 1A and 1B that the pressure equalizing element 8 is profiled exclusively in a projection surface PF (shown as a line due to the two-dimensional representation) of the pouch cell 1. Here, the projection surface PF runs perpendicular to the stacking direction SR of the pouch cell 1 is. In particular, the pouch cell 1 is free of pressure equalizing elements at its respective short end sides (left and right in FIGS. 1A and 1B).

List of reference signs

| | |
|---|---|
| 1 | Pouch cell |
| 5, 5′ | Aperture |
| 7 | Open volume |
| 8, 8′ | Pressure equalizing element |
| 9, 9′ | Housing wall |
| 10 | Rechargeable battery pack |
| KS | Convection current |
| LR | Longitudinal direction |
| PF | Projection surface |
| SR | Stacking direction |

What is claimed is:

1-13. (canceled)

14. A rechargeable battery pack for an electric hand-held power tool, the rechargeable battery pack comprising:
a housing;
at least one pouch cell arranged in the housing; and
a deformable pressure equalizer arranged parallel to the pouch cell in such a way that the pressure equalizer is yieldable to an increase in volume of the pouch cell, the pressure equalizer being profiled, so that a convection current is passable along the pouch cell in spite of increase in volume of the pouch cell.

15. The rechargeable battery pack as recited in claim 14 wherein the pressure equalizer is profiled exclusively within a projection surface of the pouch cell, the projection surface being oriented perpendicular to a stacking direction of the pouch cell.

16. The rechargeable battery pack as recited in claim 14 wherein the pressure equalizer has a waved, trapezoidal or honeycomb profile.

17. The rechargeable battery pack as recited in claim 14 wherein the pressure equalizer, perpendicular to the stacking direction, is free of a continuously straight air duct.

18. The rechargeable battery pack as recited in claim 14 wherein the pressure equalizer is reversibly-elastically deformable.

19. The rechargeable battery pack as recited in claim 14 wherein the pressure equalizer has a material elasticity greater than a cell elasticity of the pouch cell.

20. The rechargeable battery pack as recited in claim 14 wherein the pressure equalizer includes an elastomer.

21. The rechargeable battery pack as recited in claim 14 wherein the elastomer is selected from the group consisting of: polyurethane, butadiene rubber, butyl rubber, ethylenepropylene-diene rubber and silicone rubber.

22. The rechargeable battery pack as recited in claim 14 wherein the pressure equalizer is in the form of at least one insert inserted between the pouch cells.

23. The rechargeable battery pack as recited in claim 14 wherein the pressure equalizer is located between at least one of the pouch cells and a wall of the housing.

24. The rechargeable battery pack as recited in claim 14 wherein a plurality of pouch cells is provided and each of the pouch cells adjoins the pressure equalizer.

25. The rechargeable battery pack as recited in claim 14 wherein the pressure equalizer includes a phase-change material.

26. The rechargeable battery pack as recited in claim 14 wherein the at least one pouch cell is a Li-polymer cell.

27. The rechargeable battery pack as recited in claim 14 wherein a no-load voltage of the rechargeable battery pack is limited to 60 V DC voltage.
